(19) United States
(12) Patent Application Publication
(10) Pub. No.: US 2018/0272902 A1
(43) Pub. Date: Sep. 27, 2018

(54) ROTATIONAL ELEMENTS FOR SEATING ASSEMBLIES

(71) Applicant: Ford Global Technologies, LLC, Dearborn, MI (US)

(72) Inventors: Jeroen Lem, Maastricht (NL); Brian Boland, Pinckney, MI (US)

(73) Assignee: Ford Global Technologies, LLC

(21) Appl. No.: 15/469,819

(22) Filed: Mar. 27, 2017

(51) Int. Cl. B60N 2/44

(52) U.S. Cl. CPC B60N 2/448; A61H 9/0078; B60N 2/4415

(57) ABSTRACT

A vehicle seating assembly includes a seat base. A seatback is operably coupled to the seat base. A rotational element is positioned within the seatback and includes a plurality of bladders arranged in a substantially circular orientation. The plurality of bladders defines a void in a center region of the rotational element.

### FIELD OF THE INVENTION

The present disclosure generally relates to vehicle seating assemblies, and more particularly, to rotational elements for seating assemblies.

### BACKGROUND OF THE INVENTION

Massage elements within seating assemblies may provide increased comfort to users of the seating assemblies. Accordingly, it may be advantageous to incorporate such massage elements within seating assemblies.

### SUMMARY OF THE INVENTION

According to one aspect of the present disclosure, a vehicle seating assembly includes a seat base. A seatback is operably coupled to the seat base. A rotational element is positioned within the seatback and includes a plurality of bladders arranged in a substantially circular orientation. The plurality of bladders defines a void in a center region of the rotational element.

According to another aspect of the present disclosure, a vehicle seating assembly includes a seat base. A seatback is operably coupled to the seat base. A first discrete rotational element and a second discrete rotational element is positioned within the seatback. At least one of the first and second rotational elements includes a perimeter region including a plurality of bladders and a center portion free of bladders.

According to yet another aspect of the present disclosure, a vehicle seating assembly includes a seat base. A seatback is operably coupled to the seat base. A rotational element is positioned within the seatback and includes a plurality of bladders arranged in a substantially circular orientation. A valve is fluidly coupled to at least one of the bladders. The plurality of bladders are configured to inflate and deflate in a circular direction.

These and other aspects, objects, and features of the present disclosure will be understood and appreciated by those skilled in the art upon studying the following specification, claims, and appended drawings.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a perspective view of a vehicle, according to at least one example;

FIG. 2A is a front elevational view of a seating assembly, according to at least one example;

FIG. 2B is a front elevational view of a seating assembly, according to at least one example;

FIG. 3 shows the arrangement of a rotational element of the seat back relative to a muscular system of a human back, according to at least one example; and

FIG. 4 is a diagram of the vehicle, according to at least one example.

### DETAILED DESCRIPTION OF THE PREFERRED EMBODIMENTS

Additional features and advantages of the invention will be set forth in the detailed description which follows and will be apparent to those skilled in the art from the description, or recognized by practicing the invention as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

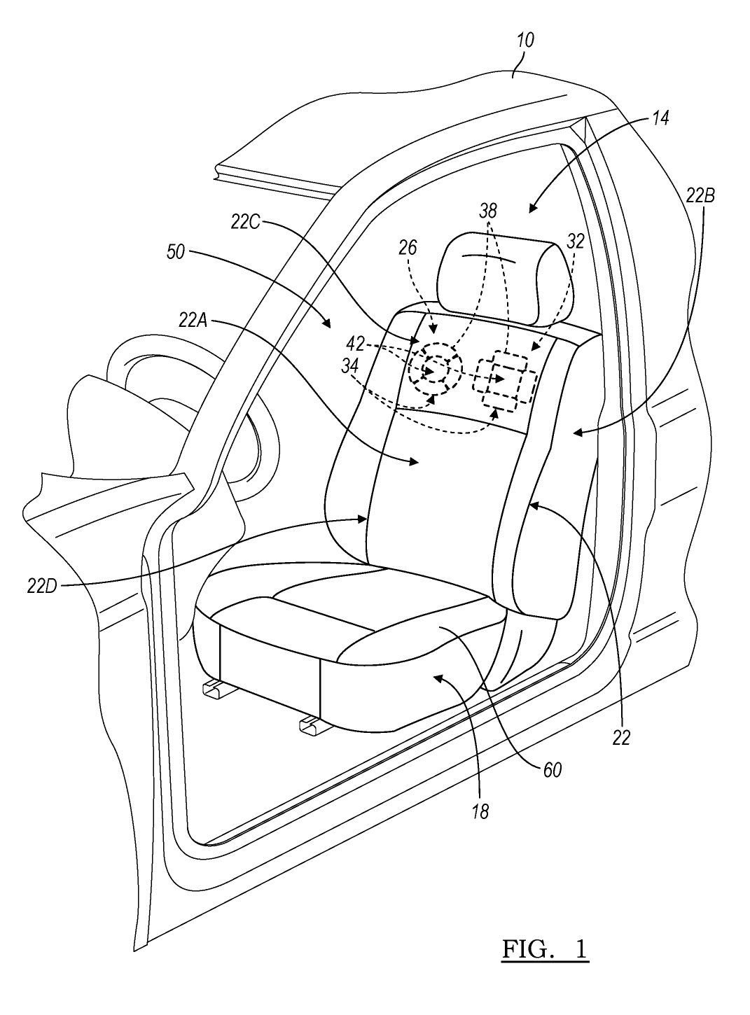

Referring now to FIGS. 1-4, reference numeral 10 generally designates a vehicle. The vehicle includes a seating assembly 14 which includes a seat base 18. A seatback 22 is operably coupled to the seat base 18. A first rotational element 26 and a second rotational element 32 are positioned within the seatback 22. At least one of the first and second rotational elements 26, 32 includes a perimeter region 34 including a plurality of bladders 38 and a center region 42 free of bladders 38.

Referring now to FIG. 1, the vehicle 10 includes a passenger cabin 50 within which the seating assembly 14 is positioned. The seating assembly 14 may be positioned in a front row or a rear row of seating. In the depicted example, the seat assembly 14 is shown as a bucket seat, but it will be understood that the seat assembly 14 may take a variety of configurations including bench seats or jump seats.

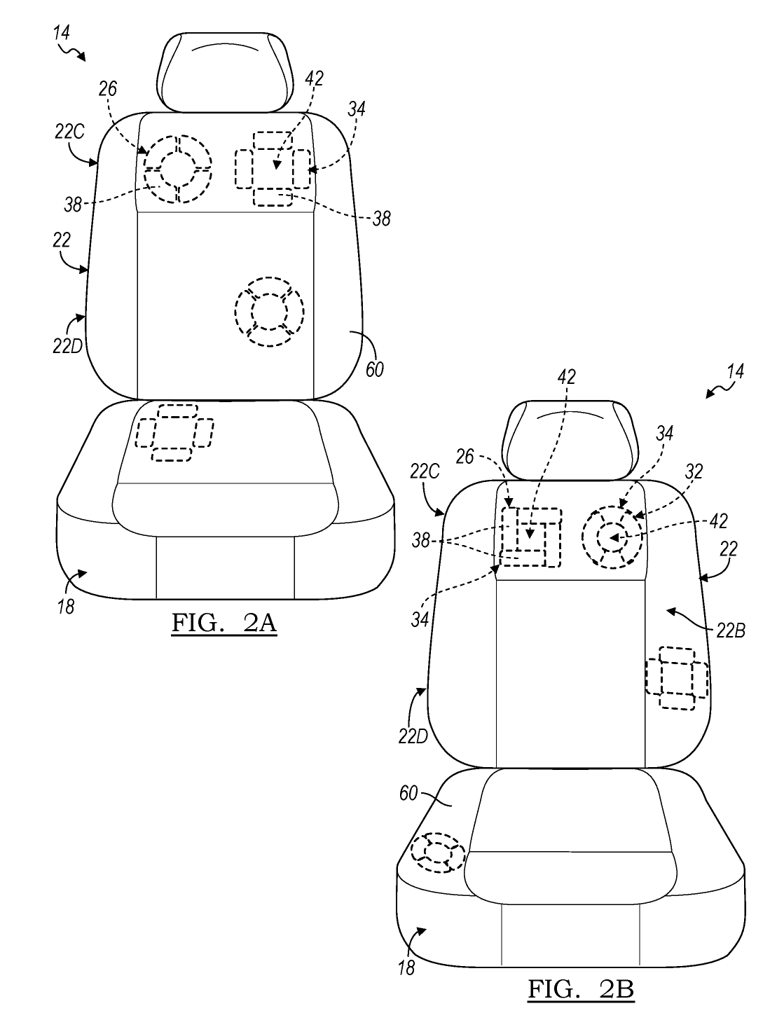

Referring now to FIGS. 1-2B, the seatback 22 of the seating assembly 14 may include a center portion 22A and side bolsters 22B positioned on inboard and outboard sides of the center portion 22A. The seatback 22 may include an upper portion 22C and a lower portion 22D. A trim component 60 is positioned over the seat assembly 14. The trim component 60 may be composed of a polymeric material, a fabric and/or natural material (e.g., leather). The trim component 60 may be stretched across the seatback 22, the seat base 18 and/or the first and second rotational elements 26, 32 to provide an aesthetically pleasing look and feel to the seating assembly 14. According to various examples, the trim component 60 may be compressible. It will be understood that the seat base 18 may include one or more other components (e.g., ventilation unit, heating element, springs, comfort carriers, massage units) without departing from the teachings provided herein.

Referring now to FIGS. 2A-2B, the first and second rotational elements 26, 32 are massage elements configured to apply pressure to an occupant positioned within the seating assembly 14. As such, the first and second rotational elements 26, 32 may be known as rotational massage elements, or simply massage elements. The first and second rotational elements 26, 32 may be configured to apply pressure in a variety of patterns including linear, random and rotational. The first and second rotational elements 26, 32 may be positioned within the seatback 22 between a substrate and/or a frame of the seatback 22 and the trim component 60. As such the first and second rotational elements 26, 32 may be held in place by the substrate and/or frame to exert pressure through the trim component 60 and into the occupant of the seating assembly 14.

Although shown and described in connection with the first and second rotational elements 26, 32, it will be understood that the seating assembly 14 may include a single rotational element (e.g., either the first or second rotational elements 26, 32) or more than two rotational elements. Further, although the first and second rotational elements 26, 32 are shown positioned within the center portion 22A of the seatback 22, it will be understood that the rotational elements 26, 32 may be positioned in the upper portion 22C, lower portion 22D, the side bolsters 22B and/or anywhere in the seat base 18 of the seating assembly 14. For example, one of the first and second rotational elements 26, 32 may be positioned in the upper portion 22C of the seatback 22 and one of the first and second rotational elements 26, 32 may be positioned in the lower portion 22D of the seatback 22.

According to various examples, the first and second rotational elements 26, 32 may be discrete from one another. For purposes of this disclosure, discrete may mean a standalone structure which is not a subpart of another structure. For example, discrete first and second rotational elements 26, 32 may be standalone structures and not subparts of a larger bladder array. Although the first and second rotational elements 26, 32 may be discrete from one another, the first and second rotational elements 26, 32 may work in conjunction with one another. For example, an activation pattern of one of the first and second rotational elements 26, 32 may be mirrored and/or performed in a complementary manner by the other rotational element.

At least one of the first and second rotational elements 26, 32 may be substantially circular. It will be understood that the first and second rotational elements 26, 32 may take a variety of configurations such as oblong, triangular, square, rectangular and higher order polygons without departing from the teachings provided herein. The first and second rotational elements 26, 32 each define the perimeter region 34 and the center region 42.

The perimeter region 34 of the first and second rotational elements 26, 32 includes the bladders 38. The perimeter region 34 may include a single bladder 38 or a plurality of bladders 38. For example, the perimeter region 34 may include two, three, four, five, six or greater than six bladders 38. It will be understood that each of the rotational elements 26, 32 may have the same or different numbers of bladders 38. As the bladders 38 are positioned within the perimeter region 34, the bladders 38 are positioned around a perimeter of the first and second rotational elements 26, 32. In circular examples of the rotational elements 26, 32 the plurality of bladders 38 may be arranged in a substantially circular orientation. In circular orientations of the rotational elements 26, 32, at least one of the bladders 38 may have a substantially arc shape and/or is semi-circular. In arc shaped or semi-circular shaped examples of the bladders 38, the bladders 38 may have a first (e.g., inner) radius and a second (e.g., outer) radius with the outer radius being greater than the inner radius. The bladders 38 may be positioned next to one another, proximate one another, in contact and/or in an overlapping (FIG. 2B) manner. In overlapping examples of the bladders 38, the bladders 38 may have an overlapping area of greater than or equal to about 1%, 5%, 10%, 20%, 30%, 40%, 50%, 60%, 70%, 80%, 90% or greater than or equal to about 99%. According to various examples, at least two of the bladders 38 are at least partially overlapping. For example, two, three, four and/or all of the bladders 38 may overlap another bladder 38 to some degree. Further, it will be understood that the first and second rotational elements 26, 32 may overlap to some degree.

The bladders 38 of the first and second rotational elements 26, 32 are operable between inflated and deflated states. Each of the bladders 38 may be independently inflatable and/or two or more bladders 38 may be linked to inflate together. The bladder 38 may be composed of a polymeric and/or elastomeric liner 38A. The liner 38A may be airtight such that gas may not permeate across the liner 38A of the bladder 38. According to various examples, the liner 38A may be configured to expand, or stretch, when inflated such that the bladders 38 may increase in size. The liner 38A of the bladder 26 defines a bladder cavity within which a fluid (e.g., gas and/or liquid) may be stored. Exemplary fluids which may transition the bladders 38 between the inflated and deflated states may include water, oil, air, gasses and/or other fluids which may enter and exit the bladders 38. It will be understood that the fluid entering and exiting the bladders 38 may be heated and/or cooled. The fluid may be moved in and out of the bladders 38 through use of a pump, a compressor and/or a tank. The first and second rotational elements 26, 32 may be coupled to a single or multiple pumps. Further, the bladders 38 may each be coupled to separate pumps or may be coupled to a single bladder 38. Fluid pressure within the bladder cavity of the bladder 38 may inflate the bladder 38 to a predetermined size and provide bladder 38 with a predetermined or designed resiliency. In the inflated state, the bladders 38 may contact the trim component 60 and press against a back of an occupant of the seating assembly 14. Increasing the fluid pressure within the bladders 38 may result in the bladder 38 pressing deeper into a back of the occupant as well as being less resilient (i.e., give a harder feeling to the bladder 38). In the inflated state, the bladders 38 may aid in providing a desired support or design to the seating assembly 14. Further, inflation of the bladders 38 may aid in providing a massaging effect to an occupant of the seating assembly 14 as explained in greater detail below.

The bladders 38 are positioned around the perimeter portion 34 to define the center region 42. The center region 42 may be a void defined by the perimeter region 34 which is free of bladders 38. In other words, the center region 42 may have no bladders 38. The center region 42 may have nothing positioned in it or may have cushion material positioned within it. In yet other examples, the bladders 38 may extend from the center region to be sector shaped. In sector shaped examples of the bladders 38, the center region 42 may be filled with the bladders 38. In yet other examples, the center region 42 may have a single or a plurality of bladders arranged as a puck. The puck positioned within the center region 42 may work (e.g., inflate and deflate) with the bladders 38, or may be operated independently.

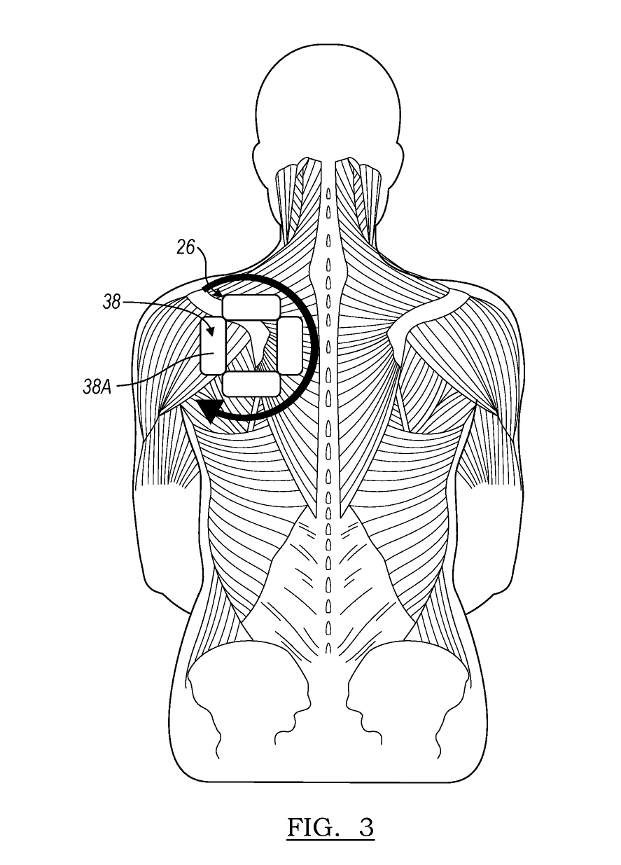

Referring now to FIG. 3, the bladders 38 of the first and second rotational elements 26, 32 are configured to inflate and apply a pressure to the muscles of an occupant's back. In the depicted example, the first rotational element 26 is positioned in contact with the occupant's back such that the bladders 38 are in contact with the occupant's deltoid and trapezius muscles. Although shown applying pressure to multiple muscles, the first and second rotational elements 26, 32 may each target a single muscle and/or the same muscle. It will be understood that although shown in connection with an upper portion of the occupant's back, the first and second rotational elements 26, 32 may be positioned anywhere throughout the seat assembly 14 such as in the lower portion 22D of the seatback 22 and/or the seat base 18 to target various muscle groups.

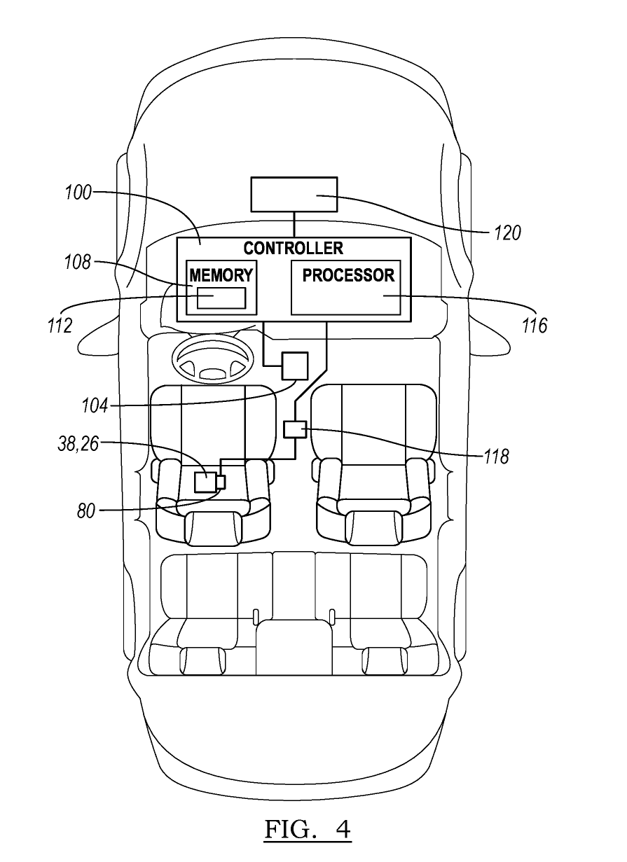

Referring now to FIG. 4, each of the bladders 38 may be fluidly coupled to a valve 80. In other words, a plurality of valves 80 may be fluidly coupled with the plurality of bladders 38. Alternatively, a single valve 80 may be coupled with all the bladders 38. The valves 80 may be fluidly coupled with the bladders 38 to allow air to pass into, and out of, the bladder cavities of the bladders 38. The valves 80 may fluidly couple the bladders 38 to the pump and/or the valves 80 may fluidly couple the bladders 38 together. The valves 80 may be actuated between open and closed states based on a signal from a controller 100 which engages a massage motion of the seat assembly 14. In the open position, the valve 80 may allow the bladders 38 to expel and intake fluid to allow the bladder 38 to reversibly transition between the deflated and inflated states. In the deflated state, the valve 80 may seal the bladder 38 such that the bladder 38 provides resiliency and does not compress under a weight from the occupant of the seating assembly 14.

The vehicle 10 includes the controller 100 which may be in communication with one or more seat control panels 104. The seat control panel 104 may be configured to allow the occupant of the seating assembly 14 to control various conditions of the seat 14. The controller 100 may include a memory 108 having a massage control routine 112 contained therein that is executed by a processor 116 of the controller 100. The controller 100 may provide electrical power to a pump 118 via a power source 120 located onboard the vehicle 10. The massage control routine 112 may be configured to control a variety of aspects of the seating assembly 14.

In a first example, the occupant of the seating assembly 14 may activate the massage control routine 112 in a rotational massage state. In such an example, the massage control routine 112 may activate the pump 118 and the valves 80 to sequentially inflate and deflate the bladders 38 around the perimeter region 34 of the first and/or second rotational elements 26, 32. As such, the plurality of bladders 38 are configured to inflate and deflate in a circular direction. Sequential activation of the bladders 38 may mean that each bladder 38 is fully inflated and fully deflated prior to inflation of the next bladder 38. As such, the plurality of bladders 38 are configured to be inflated and deflated sequentially. Additionally or alternatively, the bladders 38 may be activated in a wave pattern in which more than one bladder 38 is inflated at a time to simulate the feeling of a continuous wave moving in a circle. The rotational movement of the first rotational element 26 may be simulated to move in a clockwise and/or counterclockwise direction. The pressure applied by the bladders 38 to the occupant's back may be adjusted by the occupant through the control panel 104. The speed of the simulated rotation by the first rotational element 26 may be increased or decreased based on user preference. A heating or cooling of the bladders 38 by the fluid may be adjusted by the occupant. The rotations per minute may be altered by the occupant. It will be understood that other rotational elements (e.g., the second rotational element 32 and others) may be activated simultaneously or in conjunction with the first rotational element 26.

In a second example, the first rotational element 26 may provide a kneading and/or a knocking motion to the occupant. For example, quick inflation and deflation of the bladders 38 may provide a quick concussive force which an occupant of the seating assembly 14 may find pleasurable.

Use of the present disclosure may offer a variety of advantages. First, the presently disclosed first and second rotational elements 26, 32 provide a pleasurable massaging effect to occupants of the seating assembly 14. As explained above, the first and second rotational elements 26, 32 may offer a variety of massaging techniques. Second, use of the bladders 38 allows the seating assembly 14 to maintain a slim profile as the presence of bulky mechanical massaging elements may be minimized.

According to various embodiments, a vehicle seating assembly includes a seat base, a seatback operably coupled to the seat base and a rotational element positioned within the seatback and including a plurality of bladders arranged in a substantially circular orientation. The plurality of bladders defines a void in a center region of the rotational element. Embodiments of the vehicle seating assembly can include any one or a combination of the following features:
the bladders are positioned around a perimeter region of the rotational element;
the center region is free of bladders;
the bladders are independently inflatable;
at least two of the bladders of the plurality of bladders are at least partially overlapping;
at least one of the bladders of the plurality of bladders has a substantially arc shape;
at least one of the bladders has a substantially rectangular shape;
a plurality of valves fluidly coupled with the plurality of bladders;
a second rotational element positioned within the seatback and discrete from the first rotational element; and/or
the plurality of bladders are configured to be inflated and deflated sequentially. Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

It will be apparent to those skilled in the art that various modifications and variations can be made to the present disclosure without departing from the spirit and scope of the disclosure. Thus, it is intended that the present disclosure cover such modifications and variations provided they come within the scope of the appended claims and their equivalents. Example embodiments include the following.

What is claimed is:

1. A vehicle seating assembly, comprising:
a seat base;
a seatback operably coupled to the seat base; and
a rotational element positioned within the seatback and comprising a plurality of bladders arranged in a substantially circular orientation, wherein the plurality of bladders defines a void in a center region of the rotational element.

2. The seating assembly of claim 1, wherein the bladders are positioned around a perimeter region of the rotational element.

3. The seating assembly of claim 1, wherein the center region is free of bladders.

4. The seating assembly of claim 1, wherein the bladders are independently inflatable.

5. The seating assembly of claim 1, wherein at least two of the bladders of the plurality of bladders are at least partially overlapping.

6. The seating assembly of claim 1, wherein at least one of the bladders of the plurality of bladders has a substantially arc shape.

7. The seating assembly of claim 1, wherein at least one of the bladders has a substantially rectangular shape.

8. The seating assembly of claim 1, further comprising:
a plurality of valves fluidly coupled with the plurality of bladders.

9. The seating assembly of claim 1, further comprising:
a second rotational element positioned within the seatback and discrete from the first rotational element.

10. The seating assembly of claim 1, wherein the plurality of bladders are configured to be inflated and deflated sequentially.

11. A vehicle seating assembly, comprising:
a seat base;
a seatback operably coupled to the seat base; and
a first discrete rotational element and a second discrete rotational element positioned within the seatback, wherein at least one of the first and second rotational elements includes a perimeter region including a plurality of bladders and a center portion free of bladders.

12. The seating assembly of claim 11, wherein at least one of the bladders is semi-circular.

13. The seating assembly of claim 11, wherein at least one of the first and second rotational elements is substantially circular.

14. The seating assembly of claim 11, wherein at least one of the first and second rotational elements is positioned in an upper portion of the seatback.

15. The seating assembly of claim 11, wherein at least one of the first and second rotational elements is positioned in a lower portion of the seatback.

16. A vehicle seating assembly, comprising:
a seat base;
a seatback operably coupled to the seat base; and
a rotational element positioned within the seatback and comprising:
a plurality of bladders arranged in a substantially circular orientation, and
a valve fluidly coupled to at least one of the bladders, wherein the plurality of bladders are configured to inflate and deflate in a circular direction.

17. The seating assembly of claim 16, wherein the bladders are positioned around a perimeter region of the rotational element.

18. The seating assembly of claim 16, wherein a center region of the rotational element is free of bladders.

19. The seating assembly of claim 16, wherein the bladders are independently inflatable.

20. The seating assembly of claim 16, wherein at least one of the bladders of the plurality of bladders has a substantially arc shape.
